(19) United States
(12) Patent Application Publication
(10) Pub. No.: US 2013/0224674 A1
(43) Pub. Date: Aug. 29, 2013

(54) Shrink Systems for Labels

(71) Applicant: Associpak International Inc., (US)

(72) Inventors: Martin Malthouse, Toronto (CA); Ratnam Manoharan, Markham (CA); Gerald Smith, Ajax (CA)

(73) Assignee: Associpak International Inc., Toronto (CA)

(21) Appl. No.: 13/625,556

(22) Filed: Sep. 24, 2012

Related U.S. Application Data
(63) Continuation of application No. 12/784,196, filed on May 20, 2010, now abandoned.
(60) Provisional application No. 61/179,994, filed on May 20, 2009.

(51) Int. Cl. B65C 9/00

(52) U.S. Cl. CPC B65C 9/00
USPC 432/220

(57) ABSTRACT

A shrink system for a labelling system includes a return duct and a make up duct connected to the inlet of a fan. A valve regulates the temperature of air supplied to the inlet by varying the proportion of air flow between the return and make up ducts. The output of the fan is supplied to a nozzle configured to entrain ambient air with the outlet from the nozzle.

### CROSS REFERENCE TO RELATED APPLICATIONS

This application is a continuation of U.S. patent application Ser. No. 12/784,196 filed May 20, 2010, which claims priority from U.S. Provisional Application No. 61/179,994 filed on May 20, 2009, the contents of which are incorporated herein by reference.

### FIELD OF THE INVENTION

The present invention relates to hot air systems for use in contouring shrinkable films to containers, commonly referred to as shrink systems.

SUMMARY OF THE INVENTION

It is well known to apply a label or covering to a container as it moves along a production line. In one known arrangement, the labels are wrapped around the container by applying glue to the leading and trailing edges and brought into engagement with the container as the container rotates. The label is drawn around the container and the glue applied to the trailing edge for secures the label on the container.

Alternatively, sleeves may be preformed on a mandrel and slid onto the containers. The sleeve is dimensioned to allow relative sliding and must then be secured to the container. The application of labels allows standardised containers to be used for a range of products and reduces the warehousing and inventory necessary in a typical production facility.

It is also known to use a heat sensitive material as a label so that the label can be made to conform to shape of the container. The label is applied in a conventional manner and then passed through a shrink system where an elevated temperature causes the material of the label to shrink and conform to the outer surface of the container. Many applications pass the container through an enclosed tunnel where the temperature is elevated by super saturated steam, hot air or infra-red radiant heat. This technique however may only be used when the contents of the containers are not likely to cause an explosion. Where the contents are volatile or under pressure, such as an aerosol, there is significant risk that the container may topple and be trapped within the tunnel. Prolonged exposure to the elevated temperature may then overheat the contents and cause an explosion.

Where there is the potential for explosion therefore, the system must allow for visual observation of the containers as they pass through the heated zone. Accordingly, an open conveyor path is necessary. However, this in turn leads to an increased consumption of heating medium due to the need to replenish losses to the environment. These losses are increased by the movement of the containers at speed through the heating zone, which creates a disturbance and tends to dissipate the heated medium to the surrounding environment.

U.S. Pat. No. 1,155,799 to Tetra Alfa Holdings shows a heat tunnel arrangement tor sealing the edge of a plastic bag. A pair of hot air plenums are located on either side of the passage through which the container moves and nozzles in the side walls of the hot air plenums supply the hot air to the plastic film. A suction box is located above the gap between the two hot air plenums and has inlets to suck the hot air from between the plenums. The hot air is returned through a duct for recirculation through the hot air plenums. To induce the flow of air within the closed loop, an injector is fed from a compressed air source to create the flow. Such an arrangement however is only suitable for small articles, such as the plastic bags shown, and does not lend itself to the labelling of larger containers such as beverage cans. Moreover, the use of an ejector to induce the flow of air through the nozzles is not compatible with the flow rates of air required in most applications.

It is therefore an object of the present invention to provide a shrink system in which the above disadvantages are obviated or mitigated.

In general terms, the present invention provides a shrink system in which heated air is applied to a container. The heated air is recovered and supplied to an inlet of a fan whose outlet supplies the heated air to the containers. The recovered air is combined with an ambient air duct and the proportions of ambient air and recovered are varied to maintain a predetermined temperature as the inlet to the fan.

In a further aspect of the invention, the healed air is supplied to the container through a nozzle having convergent outer surfaces. The outer surfaces are arranged to induce a flow of air over the outer surface and entrain it with the air emitted from the nozzle. A plenum is located opposite the nozzle such that the air flowing from the nozzle and that entrained by the nozzle's airflow is constrained within the plenum.

### BRIEF DESCRIPTION OF THE DRAWINGS

An embodiment of the invention will now be described by way of example only with reference to the accompanying drawings in which:

FIG. 1 is a schematic representation of a container labelling and packaging production line.

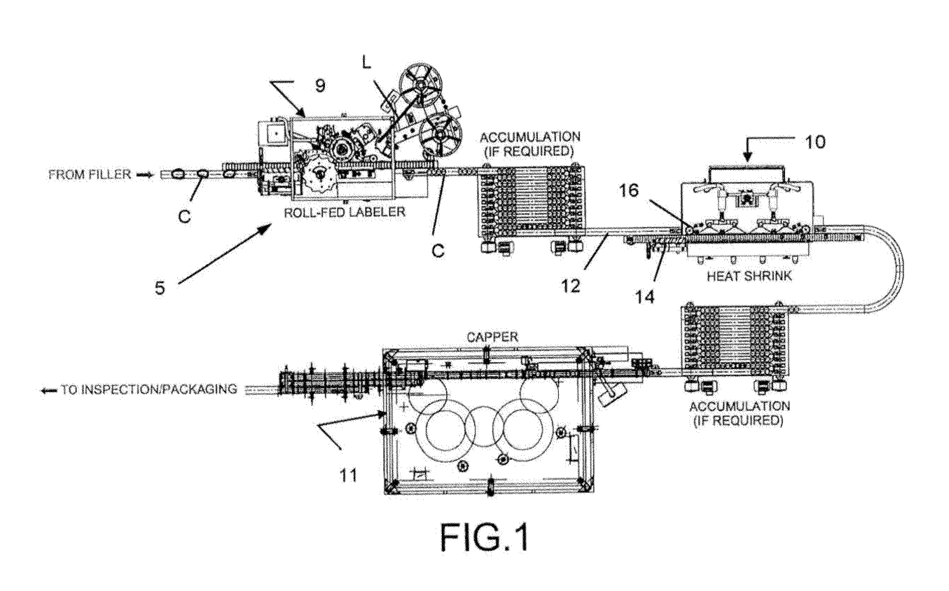

FIG. 2 is a perspective view of a shrink station incorporated into the production line of FIG. 1.

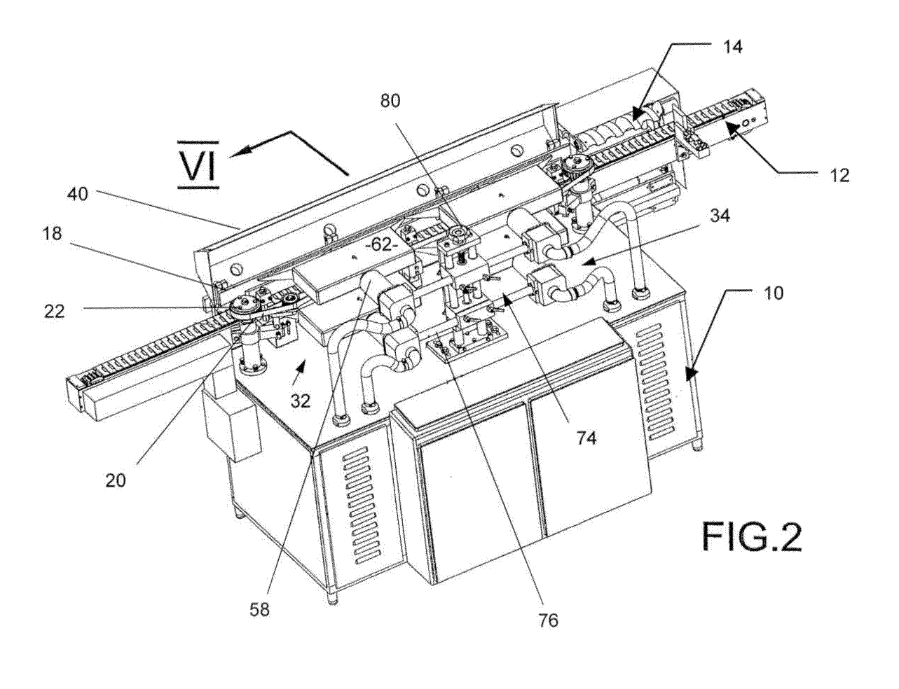

FIG. 3 is a rear perspective view of the station shown in FIG. 2.

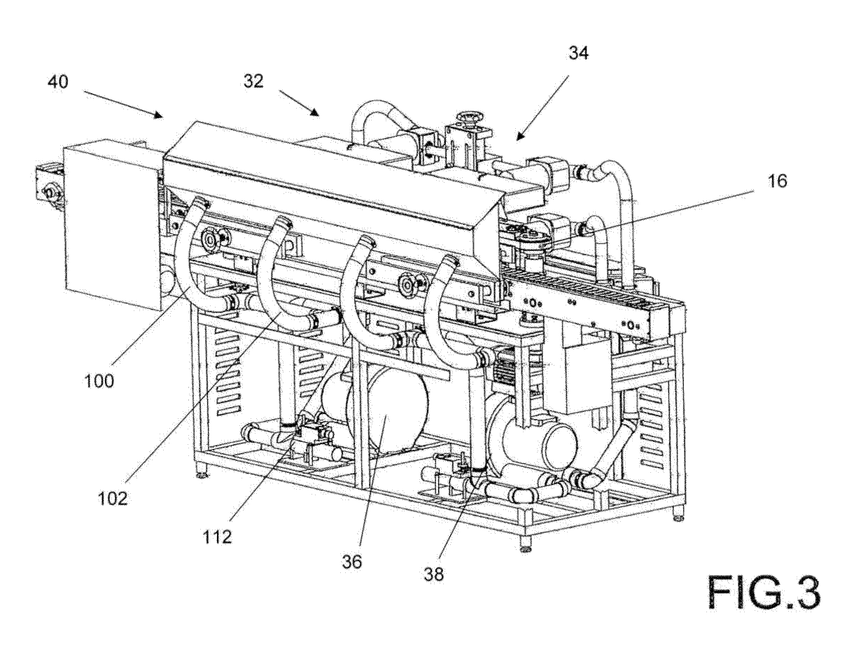

FIG. 4 is a plan view of the station shown in FIG. 2.

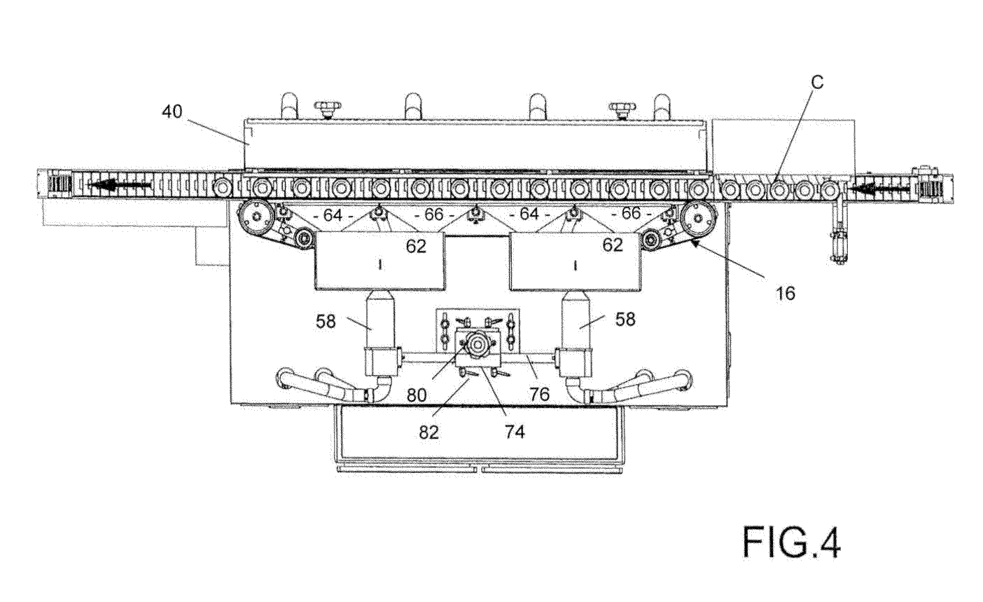

FIG. 5 is an exploded view of the station shown in FIG. 2.

FIG. 6 is a section on the line VI-VI of FIG. 2.

FIG. 7 is a perspective of a heating system used in the machine of FIG. 2.

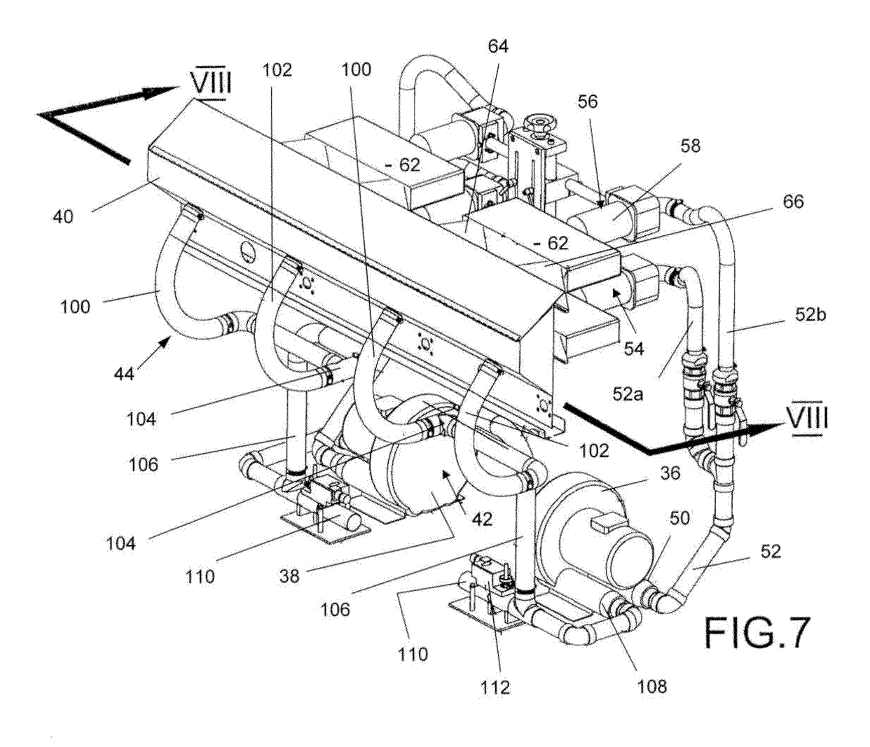

FIG. 8 is a view on the line VIII-VIII of FIG. 7.

### DETAILED DESCRIPTION OF THE INVENTION

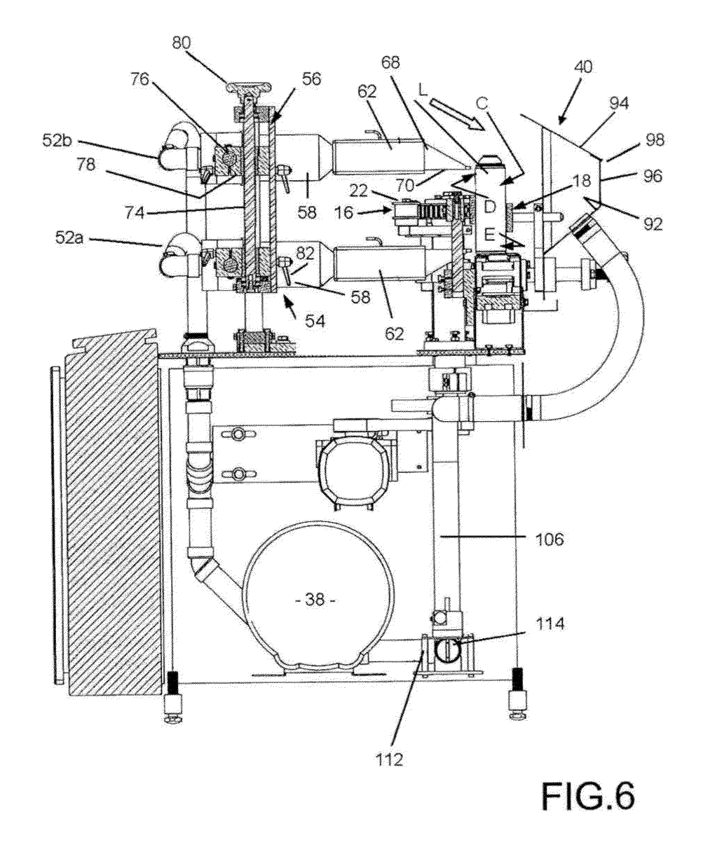

Referring therefore to the drawings, a container labelling and packaging production line, generally indicated at 5 includes a labelling machine 9, a shrink station 10 and an assembly station 11. Filled containers (C) are fed to the labelling machine 9. Labels (L) are applied to a filled container (C). The containers (C) pass from the labelling machine 9 through the shrink station 10 and are organized for placement in a package at the assembly station 11. If necessary, accumulation stations are interposed between the labelling machine and the shrink system, and between the shrink system and assembly station 11. The purpose of the shrink station 10 is to cause labels applied in the labelling station 9 to be heated and conform to the contours of the container (C) to which the labels are applied. For the purpose of the description, it will be assumed that the containers are a beverage can indicated at (C), FIG. 6, with upper and lower chines (D), (E) to which a label (L) is to conform. The label (L) is formed from a heat shrinkable material and carries indicia to decorate the external surface of the container (C).

The containers (C) are delivered to the intake of the shrink station 10 along a conveyor 12. At that time, the label (L) is formed as a cylinder adhered to the body of the container but with the upper and lower marginal edges spaced from the chines. The feed of container (C) through the station 10 is controlled by a worm assembly 14 that rotates about a horizontal axis to pick individual containers and separate them from adjacent containers as they are moved along the conveyor 12. Movement of the containers through the station 10 continues under the guidance of a belt drive 16 that receives the containers (C) from the worm assembly and rolls them along a guide rail 18 located on the opposite side of the conveyor 12 to the belt drive 16. The belt drive 16 discharges the containers (C) at the outlet of the station 10 from where they can he moved to the collection station 11.

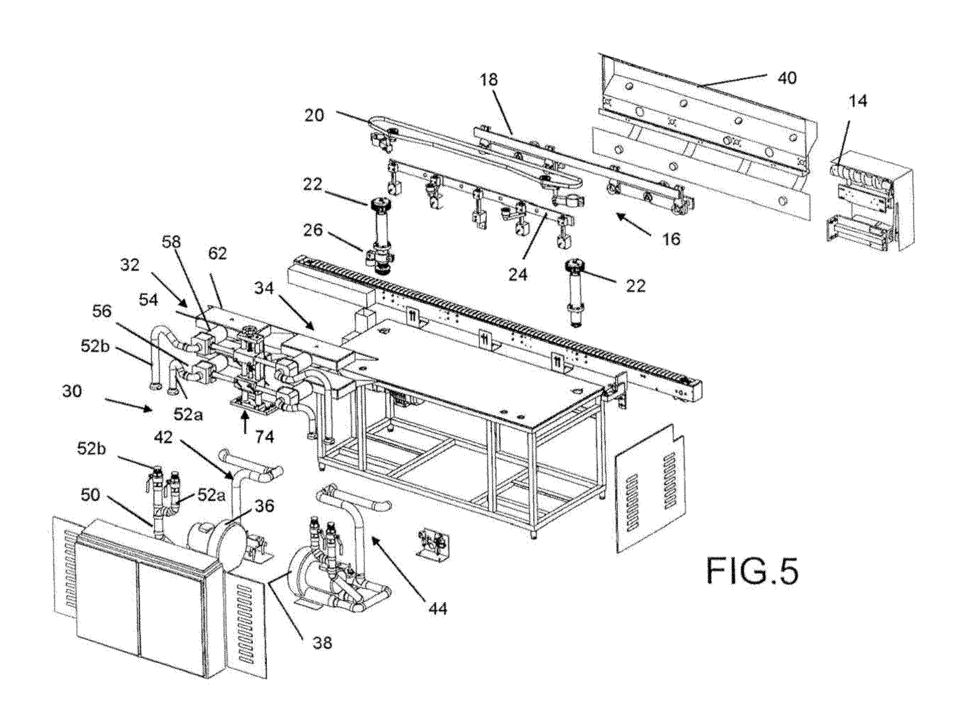

As best seen in FIG. 5, the belt drive 16 consists of an endless belt 20 entrained about a pair of pullies 22 and supported by a backing rail 24 that extends between the two pullies 22. One of the pullies 22 is driven by a motor 26 so that the belt engages the container (C) and rolls it along the guide rail 18.

A hot air system generally indicated 30 is located between the pullies 22. The hot air system 30 includes two pairs of hot air nozzle assemblies 32, 34 each supplied with air from respective fans 36, 38. A plenum 40 extends in a direction parallel to the conveyor 12 and the opposite side of the conveyor to the nozzle assemblies 32, 34 and collects air issued from the nozzle assemblies 32, 34 and returns it through return conduits 42, 44 respectively to respective ones of the fans 36, 38.

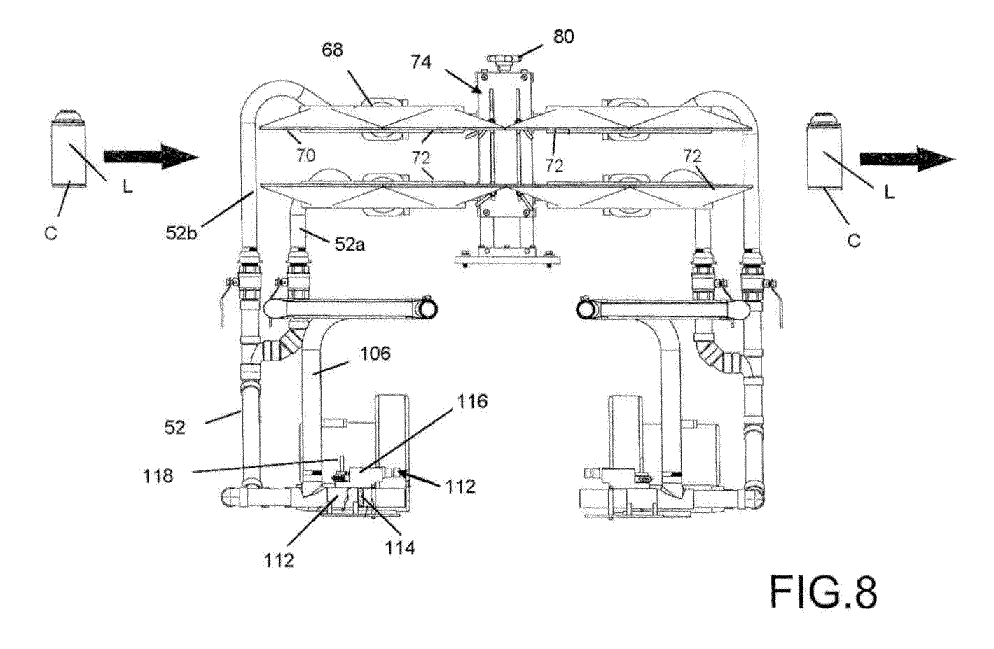

Each of the nozzle assemblies, fans and return conduits is similar and therefore only one will be described in detail. The fan 36 has an outlet 50 that is connected to a supply duct 52. The supply duct 52 branches into two separate ducts 52a, 52b which are connected to respective upper and lower heater assemblies 54, 56. Referring to FIG. 6, the heater assemblies 54, 56 each include a heater chamber 58 through which the air passes before entering a manifold 62. The chamber 58 houses an electrical resistance heating element (not shown) to elevate the temperature of the air passing through the chamber 58. The manifold 62 extends generally parallel to the conveyor 12 and has a pair of nozzles 64, 66 at opposite ends. Each of the nozzles 64, 66 has upper and lower surface 68, 70 respectively that converge in a direction toward the conveyor 12. The upper and lower surfaces 68, 70 are generally triangular with the apex adjacent to the manifold 62 so that the nozzle 64, 66 define an elongate outlet 72 that is parallel to the path of movement of a container along the conveyor 12. As an be seen in FIG. 8, the nozzles 64, 66 of the nozzle assemblies 32, 34 are positioned relative to one another to provide a substantially continuous outlet 72 between the guide pullies 22.

The heater assemblies 54, 56 are mounted on an adjustable column 74 through outriggers 76 that extend from a carriage 78. An adjustment screw 80 cooperates with the carriage 78 to allow vertical adjustment of the heater assemblies 54, 56 relative to the conveyor to facilitate alignment with the chines (D), (E) of the container (B). Locking levers 82 secure the carriage 78 to the column 74 once the adjustment is made.

The plenum chamber 40 extends between the pullies 22 on the opposite side of the conveyor 12 to the nozzle assemblies 32, 34. The plenum chamber 40 has a trapezoidal cross section with a floor 92 and a roof 94 converging in a direction away from the conveyor 12. An end wall 96 extends between the floor and roof and the roof 94 is pivoted by a hinge 98 to the end wall 96 so it may readily be opened to allow access to the conveyor.

The conduits 42, 44 each include return ducts 100, 102 that are connected to apertures in the floor 92 and are connected to one another at a tee 104 to a common return line 106. The return line 106 is connected to the inlet 108 of the respective one of the fans 36, 38 to supply return air to the fans.

Between the tee 104 and the inlet 108, a make up duct 110 is provided to draw external air into the return duct 106. Air flow into the make up duct 110 is controlled by a butterfly valve 112.

The butterfly valve 112 has a valve member 114 that is movable by a motor 116 between a closed position in which flow through the duct 110 is prevented and an open position in which relatively unrestricted flow is permitted. The motor 116 is operable on the valve member 114 to vary the position of the valve member between the open and closed positions and thereby regulate the flow of air through the make up duct 110.

The motor 116 is controlled by a thermo couple 118 that is located adjacent to the inlet 108 and measures the temperature of air provided to the fan. By modulating the valve member 114, the mixture of return and make up air may be regulated to adjust the temperature of the return air and maintain it below a predetermined level. A control 120 receives the signal indicative of the temperature from the thermo couple 118 and actuates the motor 116 to adjust the valve member so as to maintain the temperature at or about the set point.

In operation, containers (C) are fed on the conveyor 12 to the worm assembly 14 where there are individually spaced along the conveyor. The worm assembly 14 delivers the container (C) to the belt drives 16 where the belt 20 engages the body of die container (C) and rotates it along the guide rail 18 past the nozzle assemblies 32,34.

As the container (C) passes the nozzle assemblies, the relative continuous heated air stream from the nozzles 64, 66 impinges upon the unsupported edges of the label L as the container rotates past the nozzles and the heat causes the material to shrink against the chines (D), (E). The container is then discharged by the belt drive into the assembly area.

Air passing through the nozzle 64, 66 is projected transversely across the conveyor and is collected by the convergent walls of the plenum 90. The air is drawn from the plenum 90 through the return ducts 100, 102 to the inlet 108 of the fan. The provision of the plenum 90 opposite the nozzles and the negative pressure within the plenum induced by the fans 36, 38 promotes the flow of air from the nozzles into the plenum so that the hot air may be reclaimed. The temperature of the air returned through the inlet is monitored by the thermo couple 118 and modulates the butterfly valve 112 to maintain the temperature below the set point. In this manner, the temperature returned to the fan is within the normal operating range of the fans 36, 38. The temperature of air supplied by the fan through the outlet 50 is then elevated by the heaters 54, 56 but the energy supplied to maintain the desired temperature for impingement on the film may be reduced. In this manner, the energy consumption of the shrink station is significantly reduced without adversely impacting on the operation of the fans.

To mitigate the heat losses further, the upper and lower surfaces 68, 70 of the nozzles 64, 66 are configured so that the air flowing from the outlet 72 induces a flow of air across the surfaces 68, 70 and into the plenum chamber. The air flow indicated by arrows in FIG. 6, minimizes the loss of heated air through convection and reduces the heat loss through radiation as the air passes across the containers. In a typical application, the included angle between the surfaces 68, 70 is 30 degrees and the height of the outlet 72 is 525 millimetres. The transverse dimensions of the surfaces 68, 70 is 355.6 millimetres and with allow of 18 mm³ per second an effective induction of air over the surfaces is found to be generated.

It will be seen therefore that the shrink station is effective to minimize loss of energy from the air as it is forced across the conveyor and by modulation of the air intake, the energy consumption used to elevate the temperature to that required to effect shrinkage on the film of the label is reduced.

1. A shrink system to supply heated air to an exterior surface of a container, said shrink system comprising a fan to supply air, a heater to heat said air, an air outlet connected to said fan and positioned to cause air supplied by said fan to impinge on said container, a plenum chamber to collect air from said air outlet, a return duct connected between said plenum and said fan to supply air to an inlet of said fan, a make up duct connected to said inlet of said fan and a valve member to control relative proportions of air supplied to said inlet by said return duct and said make up duct, whereby the temperature of air supplied to said fan may be modulated.

2. A shrink system according to claim 1 including a control system to adjust said valve member and maintain the temperature of air supplied to said fan at a predetermined value.

3. A shrink system according to claim 2 wherein said control system includes a temperature sensor located in said inlet to said fan.

4. A shrink system according to claim 1 wherein said heater is located between said fan and said outlet.

5. A shrink system according to claim 4 wherein said outlet is a nozzle having convergent walls.

6. A shrink system according to claim 5 wherein said walls are configured to induce air flow across said walls and entrain said air flow with air from said nozzle.

7. A shrink system according to claim 6 wherein said wails converge with an included angle of 30°.

8. A shrink system according to claim 5 including a pair of nozzles, each extending along a path followed by said container and spaced to impinge said container at different locations.

9. A shrink system according to claim 5 wherein said plenum chamber is located on an opposite side of a path followed by said container to said outlet.

10. A shrink system according to claim 9 wherein said outlet includes a nozzle having convergent walls.

11. A shrink system according to claim 10 wherein a pair of nozzles are provided at spaced locations along said path and said plenum is positioned opposite each of said nozzles.

12. A shrink system to supply heated air to an exterior surface of a container, said shrink system comprising a source of heated air, an air outlet connected to said source to cause air supplied by said source to impinge upon said container, a plenum chamber to collect air from said outlet and return collected air in said plenum chamber to said source, said outlet being configured to entrain a flow of ambient air with air flowing from said outlet to impinge on said container.

13. A shrink system according to claim 12 wherein said outlet is a nozzle having convergent walls.

14. A shrink system according to claim 13 including a pair of nozzles spaced apart along a path followed by said container.

15. A shrink system according to claim 14 wherein said plenum chamber is located on opposite side of said path to said nozzles.

16. A shrink system according to claim 15 wherein a pair of nozzles are located at the same location along said path to impinge different locations on said container.

17. A shrink system according to claim 13 wherein said nozzle has an elongate outlet extending along a path followed by a container.

18. A shrink system according to claim 17 wherein said walls converge at an included angle of 30° toward said outlet.

19. A shrink system according to claim 12 wherein said source includes a fan and a heater located between said fan and said outlet.

20. A shrink system according to claim 19 wherein said plenum is connected to an inlet of said fan.
